(19) United States
(12) Patent Application Publication
(10) Pub. No.: US 2025/0314512 A1
(43) Pub. Date: Oct. 9, 2025

(54) VIBRONIC MEASURING SYSTEM

(71) Applicant: Endress+Hauser Flowtec AG, Reinach (CH)

(72) Inventor: Michael Kirst, Lörrach (DE)

(21) Appl. No.: 18/864,753

(22) PCT Filed: May 15, 2023
(86) PCT No.: PCT/EP2023/063006

§ 371 Date: Nov. 11, 2024

(30) Foreign Application Priority Data
May 18, 2022 (DE) 10 2022 112 523.8

(51) Int. Cl. G01F 1/84

(52) U.S. Cl. CPC G01F 1/8431; G01F 1/8427; G01F 1/849

(57) ABSTRACT

A measuring system comprises a measuring transducer having at least one measuring tube, an exciter arrangement, a sensor arrangement and an electronic transformer circuit having measurement and control electronics and having drive electronics connected to the measurement and control electronics and/or controlled by the measurement and control electronics. The drive electronics is designed, controlled by the measurement and control electronics, to generate an electrical driver signal in a first operating mode and thereby to feed electrical power into the exciter arrangement such that the at least one measuring tube executes forced mechanical vibrations at a vibration frequency predefined by the electrical drive signal at least during a first measuring interval, and in a second operating mode, to suspend generation of the electrical driver signal in such a manner that no electrical power is fed into the exciter arrangement by the drive electronics during said suspension.

The invention relates to a vibronic measuring system with a vibration-type measuring transducer and an electronic transformer circuit connected thereto.

In industrial measurement technology, especially also in connection with the regulation and monitoring of automated process-engineering processes, vibronic measuring systems formed by means of a transformer circuit formed mostly by means of at least one microprocessor, and a vibration-type measuring transducer which is electrically connected to said transformer circuit and through which the medium to be measured flows during operation, namely, for example, Coriolis mass flow meters, are often used for the highly accurate determination of a mass flow rate (mass flow) of a medium, e.g., a liquid, a gas, or a dispersion, flowing in a process line, e.g., a pipeline. Examples of such measuring systems designed, for example, also as Coriolis mass-flow-rate measuring devices, Coriolis mass-flow-rate/density measuring devices, and/or Coriolis mass-flow-rate/viscosity measuring devices, are described in, inter alia, EP-A 816 807, US-A 2002/0033043, US-A 2006/0096390, US-A 2007/0062309, US-A 2007/0119264, US-A 2008/0011101, US-A 2008/0047362, US-A 2008/0190195, US-A 2008/0250871, US-A 2010/0005887, US-A 2010/0011882, US-A 2010/0257943, US-A 2011/0161017, US-A 2011/0178738, US-A 2011/0219872, US-A 2011/0265580, US-A 2011/0271756, US-A 2012/0123705, US-A 2013/0042700, US-A 2016/0313162, US-A 2017/0261474, US-A 2020/0408581, US-A 44 91 009, US-A 47 56 198, US-A 47 77 833, US-A 48 01 897, US-A 48 76 898, US-A 49 96 871, US-A 50 09 109, US-A 52 87 754, US-A 52 91 792, US-A 53 49 872, US-A 57 05 754, US-A 57 96 010, US-A 57 96 011, US-A 58 04 742, US-A 58 31 178, US-A 59 45 609, US-A 59 65 824, US-A 60 06 609, US-A 60 92 429, US-B 62 23 605, US-B 63 11 136, US-B 64 77 901, US-B 65 05 518, US-B 65 13 393, US-B 66 51 513, US-B 66 66 098, US-B 67 11 958, US-B 68 40 109, US-B 69 20 798, US-B 70 17 424, US-B 70 40 181, US-B 70 77 014, US-B 72 00 503, US-B 72 16 549, US-B 72 96 484, US-B 73 25 462, US-B 73 60 451, US-B 77 92 646, US-B 79 54 388, US-B 83 33 120, US-B 86 95 436, WO-A 00/19175, WO-A 00/34748, WO-A 01/02816, WO-A 01/71291, WO-A 02/060805, WO-A 2005/093381, WO-A 2007/043996, WO-A 2008/013545, WO-A 2008/059262, WO-A 2010/099276, WO-A 2013/092104, WO-A 2014/151829, WO-A 2016/058745, WO-A 2017/069749, WO-A 2017/123214, WO-A 2017/143579, WO-A 85/05677, WO-A 88/02853, WO-A 89/00679, WO-A 94/21999, WO-A 95/03528, WO-A 95/16897, WO-A 95/29385, WO-A 98/02725, WO-A 99/40 394, or the (not pre-published) international patent application PCT/EP2021/083169.

The measuring transducer of each of the measuring systems shown therein comprises at least one at least partially straight and/or at least partially curved, e.g., U-, V-, S-, Z-, or Ω-shaped, measuring tube with a lumen surrounded by a tube wall for guiding the medium.

The at least one measuring tube of such a measurement transducer is configured to conduct medium in the lumen and to be vibrated at the same time, in particular in such a way that it carries out useful vibrations, namely mechanical vibrations around a rest position, at a useful frequency also determined by the density of the medium and consequently usable as a measure of the density. In measuring systems of the type under consideration, not least also including conventional Coriolis mass-flow-rate measuring devices, bending vibrations at a natural resonant frequency typically serve as useful vibrations, e.g., bending vibrations that correspond to a natural bending vibration fundamental mode that is intrinsic to the measuring transducer and in which the vibrations of the measuring tube are resonant vibrations that have precisely one vibration loop. In addition, with a measurement tube that is curved at least in some sections, the useful vibrations are typically designed in such a way that said measurement tube oscillates about an imaginary vibration axis connecting an inlet-side and an outlet-side end of the measurement tube in the manner of a cantilever clamped at one end, whereas, in the case of measuring transducers having a straight measurement tube, the useful vibrations are mostly bending vibrations in a single imaginary vibration plane. It is also known to excite the at least one measuring tube occasionally to forced, long-lasting, non-resonant vibrations, e.g., for the purpose of performing recurrent checks of the measuring transducer during operation of the measuring system, or else to allow free damped vibrations of the at least one measuring tube and to evaluate said free damped vibrations, in order, for instance as described, inter alia, in the aforementioned documents EP-A 816 807, US-A 2011/0178738, or US-A 2012/0123705, to detect, as early as possible, any damage to the at least one measuring tube, which can cause an undesired reduction in the measurement accuracy and/or operational reliability of the measuring system in question.

In the case of measuring transducers having two measurement tubes, these are usually integrated into the respective process line via an inlet-side distributor piece extending between the measurement tubes and an inlet-side connecting flange and via an outlet-side distributor piece extending between the measurement tubes and an outlet-side connecting flange. In the case of measuring transducers having a single measurement tube, the latter usually communicates with the process line via a connecting tube that opens on the inlet side and via a connecting tube that opens on the outlet side. Furthermore, such transducers with a single measuring tube each comprise at least one single-piece or multi-part, e.g., tubular, box-shaped, or plate-shaped, counter-oscillator, which is coupled to the measuring tube on the inlet side to form a first coupling zone and which is coupled to the measuring tube on the outlet side to form a second coupling zone, and which substantially rests in operation or oscillates in opposition to the tube. The inner part of the measuring transducer formed by means of the measurement tube and counter-oscillator is usually held in a protective measuring transducer housing solely by means of the two connecting tubes via which the measurement tube communicates with the process line during operation, in particular in a manner allowing vibrations of the inner part relative to the measuring transducer housing. In the case of the measuring transducers shown, for example, in US-A 52 91 792, US-A 57 96 010, US-A 59 45 609, US-B 70 77 014, US-A 2007/0119264, WO-A 01/02 816, or also WO-A 99/40 394, with a single, substantially straight measurement tube, the latter and the counter-oscillator are aligned substantially coaxially with one another, as is quite usual in conventional measuring transducers, in that the counter-oscillator is designed as a substantially straight hollow cylinder and is arranged in the measuring transducer such that the measurement tube is at least partially encased by the counter-oscillator. Comparatively cost-effective steel grades, such as construction steel or machining steel, are generally used as materials for such counter-oscillators, especially also when titanium, tantalum or zirconium are used for the measurement tube.

In order to actively excite or maintain vibrations of the at least one measuring tube, not least also the aforementioned useful vibrations, vibration-type measuring transducers further have an electromechanical vibration exciter which, during operation, acts differentially upon the at least one measuring tube and the possibly present counter-oscillator or the possibly present other measuring tube. The vibration exciter, which is electrically connected to the aforementioned transformer circuit by means of a pair of electric connecting lines, e.g., in the form of connecting wires and/or in the form of printed conductors of a flexible printed circuit board, is used especially, when actuated by an electric driver signal generated by drive electronics provided in the transformer circuit and correspondingly conditioned, specifically at least adapted to changing vibration properties of the at least one measuring tube, to convert an electric excitation power fed by means of said driver signal into a driving force acting upon the at least one measuring tube at a point of action formed by the vibration exciter. The drive electronics are also specifically configured to adjust the driver signal by means of internal control such that it has a signal frequency corresponding to the useful frequency to be induced, occasionally also changed over time. The driver signal can also, for example, be switched off occasionally during operation of the particular measuring system, e.g., for the purpose of enabling the aforementioned free damped vibrations of the at least one measuring tube or, for example, as proposed in the aforementioned document WO-A 2017/143579, in order to protect the drive electronics from overloading.

Vibration exciters of commercially available vibration-type measuring transducers or vibronic measuring systems of the type in question are typically constructed in the manner of an oscillating coil operating according to the electrodynamic principle, namely by means of a coil—in the case of measuring transducers with a measuring tube and a counter-oscillator coupled to it, usually fixed to the latter—and a permanent magnet which interacts with the at least one coil and serves as an armature, which is correspondingly fixed to the measuring tube to be moved. The permanent magnet and the coil are usually aligned in such a way that they extend substantially coaxially with one another. In addition, in conventional measuring transducers, the vibration exciter is usually designed and positioned such that it acts substantially centrally on the at least one measurement tube. As an alternative to a vibration exciter acting rather centrally and directly upon the measuring tube, two vibration exciters fixed on the inlet side or the outlet side of the at least one vibration element rather than in the center of the at least one vibration element can, for example, also be used for the active excitation of mechanical vibrations of the at least one measuring tube, as, inter alia, in the aforementioned document US-A 60 92 429, or, as proposed, inter alia, in US-B 62 23 605 or US-A 55 31 126, exciter assemblies formed by means of a vibration exciter acting between the counter-oscillator that may be present and the transducer housing can, for example, also be used.

Due to the useful vibrations of the at least one measuring tube—not least also in the case in which the useful vibrations of the at least one measuring tube are bending vibrations-Coriolis forces that are known to also depend upon the instantaneous mass flow rate in the flowing medium are induced. These forces can in turn cause Coriolis vibrations having the useful frequency that are dependent upon the mass flow rate and are superimposed on the useful vibrations in such a way that, between inlet-side and outlet-side vibrational movements of the at least one measuring tube carrying out the useful vibrations and being flowed through by fluid at the same time, a propagation time difference or phase difference can be detected that is also dependent upon the mass flow rate, i.e., can also be used as a measure for the mass flow rate measurement. With a measurement tube that is curved at least in some sections, with which a vibration shape in which said measurement tube is allowed to swing in the manner of a cantilever clamped at one end is selected for the useful vibrations, the resulting Coriolis vibrations correspond, for example, to the bending vibration mode, also sometimes referred to as twist mode, in which the measurement tube executes rotary vibrations about an imaginary rotary vibration axis oriented perpendicularly to the mentioned imaginary vibration axis, whereas, with a straight measurement tube, the useful vibrations of which are designed as bending vibrations in a single imaginary vibration plane, the Coriolis vibrations are, for example, bending vibrations substantially coplanar with the useful vibrations.

In order to detect both inlet-side and outlet-side vibrational movements of the at least one measuring tube, not least also those corresponding to the useful vibrations, and to generate at least two electric vibration measurement signals influenced by the mass flow rate to be measured, measuring transducers of the type in question also have two or more vibration sensors that are spaced apart from one another along the measuring tube and for example are each electrically connected by means of a separate pair of electric connecting lines to a in the aforementioned transformer circuit. Each of the vibration sensors is configured to convert the aforementioned vibration movements into a vibration measurement signal representing them, which contains a useful signal component, namely a (spectral) signal component with a signal frequency corresponding to the useful frequency, and to make the said vibration measurement signal available to the transformer circuit, e.g., to measurement and control electronics of the transformer circuit formed by means of at least one microprocessor, for further, possibly also digital, processing. In addition, the at least two vibration sensors are designed and arranged in such a way that the vibration measurement signals generated thereby not only each have a useful signal component, as already mentioned, but that a propagation time or phase difference dependent upon the mass flow rate can also be measured between the useful signal components of both vibration measurement signals. On the basis of said phase difference, the transformer circuit or its measurement and control electronics recurrently ascertains mass-flow-rate measurement values representing the mass flow rate. In addition to measuring the mass flow rate, the density and/or the viscosity of the medium can also be measured, e.g., based upon the useful frequency and/or upon an electric excitation power required for the excitation or maintenance of the useful vibrations or upon damping of the useful vibrations ascertained on the basis thereof, and output by the transformer circuit together with the measured mass flow rate in the form of qualified measurement values.

Investigations on conventional vibronic measuring systems, in particular those designed as Coriolis mass flow meters, have shown that, despite a constant mass flow rate, a significant phase error can occasionally be observed between the above-mentioned useful signal components of both vibration measuring signals, e.g., in such a way that a no longer negligible temporal change in the phase difference can be observed, or that the phase difference established between said useful signal components occasionally exhibits a volatile interference component which is not dependent upon the mass flow rate, but which is nevertheless not negligible; this is the case, for example, in applications with media that change rapidly over time with regard to density and/or viscosity or with regard to composition, in applications with inhomogeneous media, i.e., media with two or more different phases, in applications with media that are allowed to flow in time or in cycles, or also in applications with occasional medium changes during the measurement, e.g., in filling systems or in refueling devices.

As also discussed in the aforementioned US-A 2020/0408581, WO-A 2017/069749, or US-B 79 54 388, the aforementioned phase error can result, for example, from an electromagnetic coupling of the vibration signals and the driver signal (crosstalk), for example within the transformer circuit and/or within the measuring transducer. In addition, such a phase error can, however, also be attributed to the fact that the useful vibrations actively excited by means of the vibration exciter are asymmetrically damped with respect to an imaginary line of action of the driving force driving the useful vibrations, such that the excited useful vibrations—in particular in the case of measuring transducers with a single vibration exciter acting centrally upon at least one measuring tube—have a disturbance component comparable to the Coriolis vibrations.

In order to reduce or eliminate phase errors caused by electromagnetic coupling, the drive electronics of the measuring system shown in US-A 2020/0408581 are also configured, inter alia, to operate, controlled by the measurement and control electronics, optionally in a first operating mode which causes the aforementioned active excitation of the useful vibrations by means of the electrical driver signal and subsequently temporarily in a second operating mode which does not supply an electrical driver signal, in such a way that at least one measuring tube (with drive electronics operating in the first operating mode) carries out forced vibrations at least during a first measuring interval and (with drive electronics operating in the second operating mode) carries out free damped vibrations at least during a second measuring interval. In addition, the measurement and control electronics of the measuring system shown in US-A 2020/0408581 are configured to determine the mass-flow-rate measurement value based upon the first and second vibration measurement signals received at least during a second measuring interval and not (or no longer) containing the aforementioned interference component, or their respective phase difference not (or no longer) containing the phase error.

One disadvantage of such a determination of mass-flow-rate measurement values is, inter alia, that the phase angles or phase differences required for this must be determined based upon the vibration signals of the decaying free vibrations, which are actually less suitable in terms of their signal-to-noise ratio (SN).

Based upon the aforementioned prior art, one object of the invention is to improve vibronic measuring systems of the aforementioned type in such a way that the time-varying phase error during operation can be repeatedly determined at least approximately, in particular quantified, and/or taken into account accordingly when determining mass-flow-rate measurement values. To achieve the object, the invention consists of a vibronic measuring system, e.g., a Coriolis mass flow meter, which measuring system comprises:
a measuring transducer with at least one measuring tube, with an exciter arrangement and with a sensor arrangement;
and an electronic transformer circuit electrically coupled both to the exciter arrangement and to the sensor arrangement, e.g., formed and/or programmable by means of at least one microprocessor, with measurement and control electronics and with drive electronics connected to the measurement and control electronics, e.g., electrically, and/or controlled by the measurement and control electronics;
wherein the measuring tube is configured to guide a fluid measuring substance, e.g., a gas, a liquid, or a dispersion, which flows at least intermittently and to be vibrated during this;
wherein the exciter arrangement is configured to convert electric power fed to it into mechanical power causing forced mechanical vibrations of the at least one measuring tube;
wherein the sensor arrangement is configured to detect mechanical vibrations of the at least one measuring tube and to provide a first vibration measurement signal at least partially representing vibration movements of the at least one measuring tube and at least one second vibration measurement signal at least partially representing vibration movements of the at least one measuring tube, e.g., in such a way that the said first and second vibration measurement signals follow a change in a mass flow rate of the measuring substance guided in the measuring tube with a change in a phase difference, namely a change in a difference between a phase angle of the first vibration measurement signal and a phase angle of the second vibration measurement signal;
wherein the drive electronics are configured to generate an electrical driver signal in a first operating mode and thereby to feed electrical power into the exciter arrangement, such that the at least one measuring tube carries out forced mechanical vibrations with at least one useful frequency, namely a vibration frequency predetermined by the electrical driver signal, e.g., corresponding to a resonance frequency of the measuring transducer, and the first vibration measurement signal has a first phase angle and the second vibration measurement signal has a second phase angle,
and wherein the drive electronics are configured to suspend generation of the electrical driver signal in a second operating mode, in such a way that, during this time, no electrical power is fed into the exciter arrangement by the drive electronics;
wherein the measurement and control electronics are configured to control the drive electronics in such a way that the drive electronics initially operate in the first operating mode, e.g., temporarily and/or for longer than a reciprocal of the useful frequency and/or for longer than 10 ms in each case, and the at least one measuring tube (with drive electronics operating in the first operating mode) executes forced vibrations at least during a first measuring interval corresponding to, for example, more than a reciprocal of the useful frequency and/or lasting longer than 10 ms, and that the drive electronics subsequently switch from the first operating mode to the second operating mode (and vice versa) or operate alternately in the first operating mode or in the second operating mode, whereby the at least one measuring tube (with drive electronics operating in the second operating mode) executes free damped vibrations at least during a second measuring interval corresponding, for example, to more than a reciprocal of the useful frequency and/or lasting longer than 10 ms and/or less than 1 s, and the first vibration measurement signal has a third phase angle and the second vibration measurement signal has a fourth phase angle;
and wherein the measurement and control electronics are configured to receive and evaluate the first and second vibration measurement signals, namely both to determine one or more, e.g., digital, mass-flow-rate measurement values, namely the mass flow rate (of the medium guided in the at least one measuring tube), based upon first and second vibration measurement signals received at least during one or more first measuring intervals, and also to determine, based upon first and second vibration measurement signals received respectively during one or more first and second measuring intervals one or more, e.g., digital, phase error measurement values, a, for example, absolute or relative, (measurement) deviation of one or more first phase angles (of the first vibration measurement signal received during one or more first measuring intervals) from one or more third phase angles (of the first vibration measurement signal received during one or more second measuring intervals) and/or a, for example, absolute or relative, (measurement) deviation of one or more second phase angles (of the second vibration measurement signal received during one or more first measuring intervals) from one or more fourth phase angles (of the second vibration measurement signal received during one or more second measuring intervals) and/or a (measurement) deviation, for example absolute or relative, of one or more first phase differences of the first and second vibration measurement signals received during one or more first measuring intervals from one or more second phase differences of the first and second vibration measurement signals received during one or more second measuring intervals.

Furthermore, the invention also consists in using such a measuring system for measuring and/or monitoring a fluid measured material, e.g., a gas, a liquid, or a dispersion, which flows at least intermittently in a pipeline and is, for example, at least intermittently inhomogeneous and/or at least intermittently 2-phase or multi-phase.

According to a first embodiment of the measuring system of the invention, it is further provided that the measurement and control electronics be configured to determine one or more mass-flow-rate measurement values using one or more phase error measurement values, e.g., in such a way that the measurement and control electronics are configured to use one or more phase error measurement values to determine at least one correction value useful for reducing or compensating for a phase error contained in the first phase differences (of the first and second vibration measurement signals received during one or more first measuring intervals) and to take this into account when determining the mass-flow-rate measurement values or to calculate the mass-flow-rate measurement values using the at least one correction value.

According to a second embodiment of the measuring system of the invention, it is further provided that the measurement and control electronics be configured to calculate one or more characteristic values for at least one statistical (measuring system) characteristic value, e.g., a position measure or a dispersion measure of a measurement value ensemble comprising a plurality of phase error measurement values, for example in such a way that one or more characteristic values quantify a (central) tendency of the phase error measurement values and/or that one or more characteristic values quantify a dispersion parameter of the phase error measurement values.

According to a third embodiment of the measuring system of the invention, it is further provided that one or more phase error measurement values represent, e.g., quantify, a (central) tendency, e.g., a mode, a median, an (empirical) mean value, of the (measurement) deviation of one or more first phase angles from one or more second phase angles.

According to a fourth embodiment of the measuring system of the invention, it is further provided that one or more phase error measurement values represent, e.g., quantify, a (central) tendency, e.g., a mode, a median, an (empirical) mean value, of the (measurement) deviation of one or more third phase angles from one or more fourth phase angles.

According to a fifth embodiment of the measuring system of the invention, it is further provided that one or more phase error measurement values represent, e.g., quantify, a (central) tendency, e.g., a mode, a median, an (empirical) mean value, of the (measurement) deviation of one or more first phase differences from one or more second phase differences.

According to a sixth embodiment of the measuring system of the invention, it is further provided that one or more phase error measurement values represent, e.g., quantify, a dispersion parameter, e.g., an (empirical) variance, an (empirical) standard deviation, or a range, of the (measurement) deviation of one or more first phase angles from one or more second phase angles.

According to a seventh embodiment of the measuring system of the invention, it is further provided that one or more phase error measurement values represent, e.g., quantify, a dispersion parameter, e.g., an (empirical) variance, an (empirical) standard deviation, or a range, of the (measurement) deviation of one or more second phase angles from one or more fourth phase angles.

According to an eighth embodiment of the measuring system of the invention, it is further provided that one or more phase error measurement values represent, e.g., quantify, a dispersion parameter, e.g., an (empirical) variance, an (empirical) standard deviation, or a range, of the (measurement) deviation of one or more first phase differences from one or more second phase differences.

According to a ninth embodiment of the measuring system of the invention, it is further provided that the measurement and control electronics be configured to determine a deviation of one or more phase error measurement values from at least one phase error reference value that, for example, represents a phase error measurement value determined under reference conditions and/or during a (re-) calibration of the measuring system.

According to a tenth embodiment of the measuring system of the invention, it is further provided that the measurement and control electronics be configured to compare one or more phase error measurement values with at least one phase error threshold value, e.g., one that is specific to the measuring system and/or represents a maximum permissible phase error measurement value or a fault in the measuring system and/or the measured material, for example to output an (error) message if one or more phase error measurement values have exceeded the at least one phase error threshold value.

According to an eleventh embodiment of the measuring system of the invention, it is further provided that the measurement and control electronics be configured to determine one or more mass-flow-rate measurement values based also upon first and second vibration measurement signals received during one or more second measuring intervals.

According to a twelfth embodiment of the measuring system of the invention, it is further provided that the measurement and control electronics be configured to determine, based upon first vibration measurement signals received during one or more first measuring intervals, one or more, e.g., digital, (first) phase angle measurement values representing the first phase angle (of the first vibration measurement signal received during one or more first measuring intervals).

According to a thirteenth embodiment of the measuring system of the invention, it is further provided that the measurement and control electronics be configured to determine, based upon second vibration measurement signals received during one or more first measuring intervals, one or more, e.g., digital, (second) phase angle measurement values representing the second phase angle (of the second vibration measurement signal received during one or more first measuring intervals).

According to a fourteenth embodiment of the measuring system of the invention, it is further provided that the measurement and control electronics be configured to determine, based upon first vibration measurement signals received during one or more first measuring intervals, one or more, e.g., digital, (third) phase angle measurement values representing the third phase angle (of the first vibration measurement signal received during one or more second measuring intervals).

According to a fifteenth embodiment of the measuring system of the invention, it is further provided that the measurement and control electronics be configured to determine, based upon second vibration measurement signals received during one or more second measuring intervals, one or more, e.g., digital, (fourth) phase angle measurement values representing the fourth phase angle (of the second vibration measurement signal received during one or more second measuring intervals).

According to a sixteenth embodiment of the measuring system of the invention, it is further provided that the measurement and control electronics be configured to determine, based upon first and second vibration measurement signals received during one or more first measuring intervals, one or more, in particular digital, (first) phase difference measurement values (X_{Δφ1}), namely measurement values representing the (first) phase difference of the first and second vibration measurement signals (received during one or more first measuring intervals). Developing this embodiment of the invention, it is further provided that the measurement and control electronics be configured to determine one or more mass-flow-rate measurement values using one or more first phase difference measurement values.

According to a seventeenth embodiment of the measuring system of the invention, it is further provided that the measurement and control electronics be configured to determine, based upon first and second vibration measuring signals received during one or more second measuring intervals, one or more, e.g., digital, (second) phase difference measurement values, namely measuring values representing the (second) phase difference of the first and second vibration measuring signals (received during one or more second measuring intervals). Developing this embodiment of the invention, it is further provided that the measurement and control electronics be configured to determine one or more mass-flow-rate measurement values using one or more second phase difference measurement values.

According to an eighteenth embodiment of the measuring system of the invention, it is further provided that the transformer circuit, e.g., its measurement and control electronics, be configured, e.g., when the drive electronics are operating in the first operating mode or before switching the drive electronics from the first to the second operating mode, to generate a message, e.g., to output it by means of a control signal and/or to transmit it to a display element of the measuring system, which indicates or causes the mass flow of the measurement material guided in the at least one measuring tube to be set to a constant, in particular zero, (mass flow rate) value.

According to a nineteenth embodiment of the measuring system of the invention, it is further provided that the transformer circuit, e.g., its measurement and control electronics, be configured to effect a change, e.g., multiple changes, of the drive electronics from the first operating mode to the second operating mode (and vice versa) automatically, e.g., in a time—and/or event-controlled manner, and/or based upon a control signal applied to the transformer circuit, for example triggered by a (start) command transmitted thereby and/or a message transmitted thereby that the mass flow of the measured material guided in the at least one measuring tube is constant or zero.

According to a twentieth embodiment of the measuring system of the invention, it is further provided that the sensor arrangement for detecting mechanical vibrations of the at least one measuring tube have a—for example, electrodynamic and/or at the inlet side-first vibration sensor (51) providing the first vibration measurement signal and a—for example, electrodynamic and/or at the outlet side and/or identical in design to the first vibration sensor-second vibration sensor providing the second vibration measurement signal, and for example have no further vibration sensor apart from the first and second vibration sensors.

According to a twenty-first embodiment of the measuring system of the invention, it is furthermore provided that the exciter arrangement have a vibration exciter, e.g., an electrodynamic and/or single, first vibration exciter, for exciting vibrations of the at least one measuring tube.

According to a twenty-second embodiment of the measuring system of the invention, it is further provided that the drive electronics be electrically connected to the exciter arrangement.

According to a twenty-third embodiment of the measuring system of the invention, it is further provided that the measurement and control electronics be electrically coupled to the sensor arrangement.

According to a twenty-fourth embodiment of the measuring system of the invention, it is further provided that the measurement and control electronics have a first analog-to-digital converter for the first vibration measurement signal and a second analog-to-digital converter for the second vibration measurement signal.

According to a twenty-fifth embodiment of the measuring system of the invention, the measurement and control electronics are configured to determine phase error measurement values (also) for the case in which measurement material flows through the measuring transducer at a mass flow rate different from zero, for example at least approximately constant or stationary for a plurality of successive first and second measuring intervals.

According to a first further development of the measuring system of the invention, this system further comprises: a display element.

According to a first embodiment of the first further development, it is further provided that the transformer circuit be designed to generate control signals for the display element and to output them to the display element.

According to a second embodiment of the first further development, it is further provided that the display element be designed to receive and process one or more control signals from the transformer circuit, for example to display one or more messages transmitted by means of one or more control signals.

According to a second further development of the measuring system of the invention, this system further comprises: an operating element.

According to a first embodiment of the second further development, it is further provided that the operating element be configured to convert one or more manual inputs into one or more control signals, e.g., containing one or more (control) commands for the transformer circuit, and to send them to the transformer circuit.

According to a second embodiment of the second further development, it is further provided that the transformer circuit be configured to receive and process one or more control signals from the operating element, e.g., containing one or more (control) commands, for example to execute one or more (control) commands transmitted by means of one or more control signals.

A basic idea of the invention is to occasionally suspend the active excitation of the useful vibrations required for the measurement of the mass flow rate during the detection of the useful vibrations, namely not to feed a drive signal into the exciter arrangement, whereby the coupling of the electrical excitation signal into each of the at least two vibration signals and the asymmetrical driving of the useful vibrations as a whole-recognized here as a cause of the aforementioned interference components or the resulting phase error—is avoided, and to determine the phase error (during operation of the measuring system) on the basis of both the vibration signals for the actively excited (useful) vibrations and the vibration signals for free (damped) vibrations, for example namely to quantify the error and/or to take the contribution of the phase error into account accordingly in the determination of the mass flow rate measurement values, in particular to reduce or eliminate it.

One advantage of the invention is to be seen, inter alia, in the fact that established measuring transducers and transformer circuits—for example, known from US-B 63 11 136 mentioned above or US-A 2020/0408581, or also offered by applicant for Coriolis mass flow meters (http://www.endress.com/de/messgeraete-fuer-die-prozesstechnik/produktfinder?filter.business-area=flow&amp;filter.measuring-principle-parameter=coriolis&amp;filter.text=)—can in principle be incorporated, i.e., can also be used if appropriate by means of comparatively minor modifications to the software or firmware of the relevant transformer circuits, for example by retrofitting already-installed measuring systems on-site.

The invention as well as advantageous embodiments thereof are explained in more detail below based upon exemplary embodiments shown in the figures of the drawing. Identical or identically acting or identically functioning parts are provided with the same reference signs in all figures; for reasons of clarity or if it appears sensible for other reasons, reference signs mentioned before are dispensed with in subsequent figures. Further advantageous embodiments or developments, especially, combinations of partial aspects of the invention that were initially explained only separately, furthermore emerge from the figures of the drawing and/or from the claims themselves.

In the figures in detail:

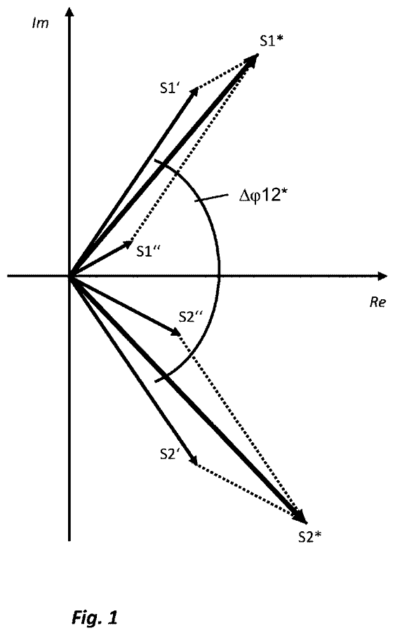

FIG. 1 is a vector diagram for signal components of vibration measurement signals generated by conventional Coriolis mass flow meters;

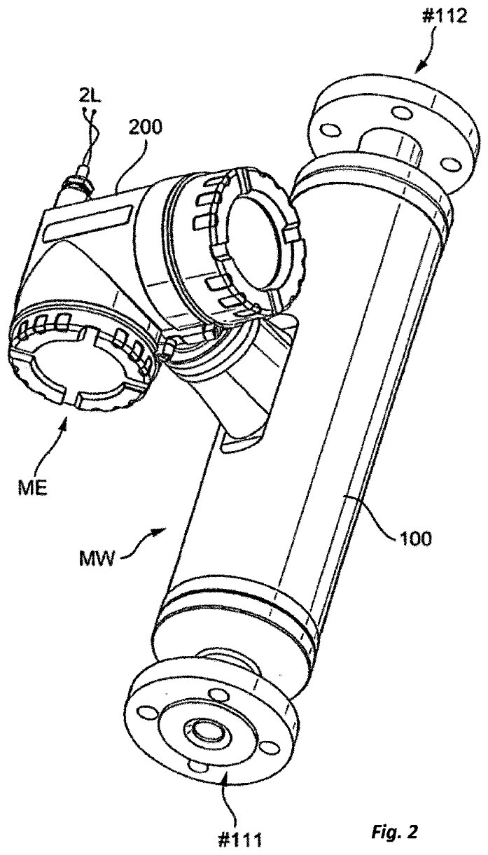

FIG. 2 shows a Coriolis mass flow meter designed here as a compact meter;

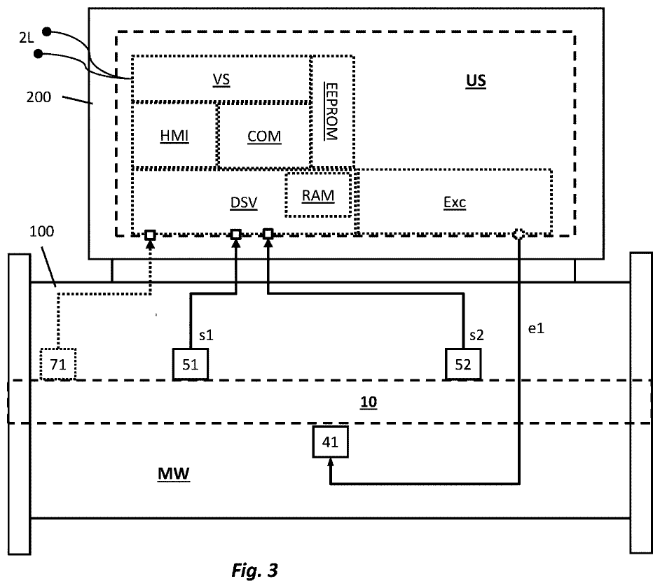

FIG. 3 schematically shows, as a block diagram, a transformer circuit, in particular suitable for a Coriolis mass flow meter according to FIG. 2, with a vibration-type measuring transducer connected thereto or a Coriolis mass flow meter according to FIG. 2;

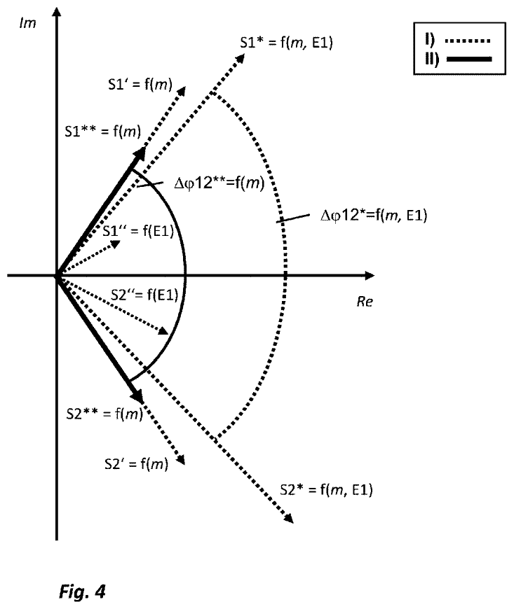

FIG. 4 shows a phasor diagram (vector diagram with static vectors) for signal components of vibration measurement signals generated by means of a Coriolis mass flow meter according to FIG. 2 or by means of a transformer circuit according to FIG. 3 connected to a vibration-type measuring transducer.

FIGS. 2 and 3 show a vibronic measuring system that can be inserted into a process line (not shown here), such as a pipeline of an industrial plant, e.g., of a filling plant or a refueling device, for flowable measurement media, in particular fluid or pourable measurement media, namely, for example, also a fluid that is at least intermittently 2-phase or multi-phase or inhomogeneous. The measuring system, e.g., formed as a Coriolis mass flow meter, is used in particular for measuring and/or monitoring a mass flow m or for determining mass-flow-rate measurement values (X_{M}) representing the mass flow rate of a fluid substance to be measured that is conducted in the aforementioned process line or at least intermittently caused to flow therein, for example specifically, a gas, a liquid, or a dispersion.

Furthermore, the measuring system can also be used to determine a density p and/or a viscosity n of the measured material. According to one embodiment of the invention, it is provided to use the measuring system for determining mass-flow-rate measurement values of a measurement medium that is to be transferred, namely, for example, to be delivered in a specified or specifiable amount by a supplier to a customer, for example a liquefied gas, such as a liquid gas containing methane and/or ethane and/or propane and/or butane, or a liquefied natural gas (LNG), or also a mixture of substances formed by means of liquid hydrocarbons, namely, for example, a petroleum or a liquid fuel. The measuring system can accordingly also be designed, for example, as a component of a transfer point for freight traffic subject to calibration obligations, such as a refueling plant, and/or as a component of a transfer point, in the manner of the transfer points disclosed in the mentioned documents WO-A 02/060805, WO-A 2008/013545, WO-A 2010/099276, WO-A 2014/151829, or WO-A 2016/058745.

The measuring system comprises a physical-electrical measuring transducer MW, connected to the process line via an inlet end #111 and an outlet end #112, which is configured to be flowed through by the measured material during operation, as well as an electronic transformer circuit US electrically coupled to it—in particular supplied with electrical energy during operation by means of internal energy storage and/or externally via a connecting cable.

Advantageously, the transformer circuit US, which is, for example, also programmable and/or able to be remotely parametrized, can furthermore be designed such that it can exchange measurement data and/or other operating data, such as current measurement values or setting values and/or diagnostic values used to control the measuring system, with a higher-level electronic data processing system (not shown here), e.g., a programmable logic controller (PLC), a personal computer, and/or a workstation, via a data transmission system, e.g., a field bus system and/or a wireless radio connection, during the operation of the measuring system. Accordingly, the transformer circuit US can have, for example, such connecting electronics, fed during operation by a (central) evaluation and supply unit provided in the aforementioned data processing system and remote from the measuring system. For example, the transformer circuit US (or its aforementioned connecting electronics) can be designed such that it can be connected electrically to the external electronic data processing system via a two-conductor connection 2L, optionally also configured as a 4-20 mA current loop, and, via said connection, can both obtain the electric power required for operating the measuring system from the aforementioned evaluation and supply unit of the data processing system and transmit measurement values to the data processing system, e.g., by (load) modulation of a direct supply current fed by the evaluation and supply unit.

In addition, the transformer circuit US can also be designed such that it can be operated nominally at a maximum power of 1 W or less and/or is intrinsically safe.

The measuring transducer MW is a measuring transducer of the vibration type, namely a measuring transducer with at least one measuring tube 10, with an exciter arrangement 41 and with a sensor arrangement (51, 52), wherein the at least one measuring tube 10 is configured to guide the at least intermittently flowing fluid measured material (or to be flowed through by said material) and to be vibrated at least intermittently during this process. As is also indicated in FIG. 3, or easily seen in a combined view of FIGS. 2 and 3, the at least one measuring tube 10 can also be accommodated within a transducer housing 100, together with the exciter arrangement (41) and the sensor arrangement, as well as any other components of the measuring transducer. The measuring sensor can accordingly also be, for example, a conventional vibration-type measuring sensor known from the prior art, not least from the aforementioned documents EP-A 816 807, US-A 2002/0033043, US-A 2006/0096390, US-A 2007/0062309, US-A 2007/0119264, US-A 2008/0011101, US-A 2008/0047362, US-A 2008/0190195, US-A 2008/0250871, US-A 2010/0005887, US-A 2010/0011882, US-A 2010/0257943, US-A 2011/0161017, US-A 2011/0178738, US-A 2011/0219872, US-A 2011/0265580, US-A 2011/0271756, US-A 2012/0123705, US-A 2013/0042700, US-A 2016/0313162, US-A 2017/0261474, US-A 2020/0408581, US-A 44 91 009, US-A 47 56 198, US-A 47 77 833, US-A 48 01 897, US-A 48 76 898, US-A 49 96 871, US-A 50 09 109, US-A 52 87 754, US-A 52 91 792, US-A 53 49 872, US-A 57 05 754, US-A 57 96 010, US-A 57 96 011, US-A 58 04 742, US-A 58 31 178, US-A 59 45 609, US-A 59 65 824, US-A 60 06 609, US-A 60 92 429, US-B 62 23 605, US-B 63 11 136, US-B 64 77 901, US-B 65 05 518, US-B 65 13 393, US-B 66 51 513, US-B 66 66 098, US-B 67 11 958, US-B 68 40 109, US-B 69 20 798, US-B 70 17 424, US-B 70 40 181, US-B 70 77 014, US-B 72 00 503, US-B 72 16 549, US-B 72 96 484, US-B 73 462, US-B 73 60 451, US-B 77 92 646, US-B 79 54 388, US-B 83 33 120, US-B 86 95 436, WO-A 00/19175, WO-A 00/34748, WO-A 01/02816, WO-A 01/71291, WO-A 02/060805, WO-A 2005/093381, WO-A 2007/043996, WO-A 2008/013545, WO-A 2008/059262, WO-A 2010/099276, WO-A 2013/092104, WO-A 2014/151829, WO-A 2016/058745, WO-A 2017/069749, WO-A 2017/123214, WO-A 2017/143579, WO-A 85/05677, WO-A 88/02853, WO-A 89/00679, WO-A 94/21999, WO-A 95/03528, WO-A 95/16897, WO-A 95/29385, WO-A 98/02725, WO-A 99/40 394, or PCT/EP2017/067826. The exciter arrangement of the measuring transducer is accordingly configured to convert electrical power fed therein into mechanical power causing forced mechanical vibrations of the at least one measuring tube, while the sensor arrangement of the measuring transducer is configured to detect mechanical vibrations of the at least one measuring tube 10 and to provide a first vibration measurement signal s1 representing at least part of the vibration movements of the at least one measuring tube and at least one second vibration measurement signal s2 representing at least part of the vibration movements of the at least one measuring tube; this in particular in such a way that the said vibration measurement signals correspond to a change in the mass flow rate of the medium being measured in the measuring tube with a change in at least one phase difference Δφ12 (Δφ12*), namely a change in at least one difference between a phase angle φ1 of the vibration measurement signal s1 (or one of its spectral signal components) and a phase angle φ2 of the vibration measurement signal s2 (or one of its spectral signal components). Furthermore, the vibration measurement signals s1, s2 can have at least one signal frequency and/or signal amplitude dependent upon the density and/or viscosity of the measured material. According to a further embodiment of the invention, the sensor arrangement according to the invention comprises a—for example, electrodynamic or piezoelectric or capacitive-first vibration sensor 51 attached at the inlet side of at least one measuring tube or arranged in its vicinity, and a—for example, electrodynamic or piezoelectric or capacitive-second vibration sensor 52 attached at the outlet side of at least one measuring tube or arranged in its vicinity. As is quite common with vibration-type measuring transducers and also indicated in FIG. 3, the vibration sensors 51, 52 can for example also be positioned at the same distance from the center of the at least one measuring tube 10. In addition, the two vibration sensors 51, 52 can also be the only vibration sensors that are used to detect vibrations of the at least one measuring tube 10, such that the sensor arrangement does not have any other vibration sensors apart from said vibration sensors 51, 52. According to a further embodiment of the invention, the exciter arrangement is formed by means of at least one electromechanical—for example, electrodynamic, electromagnetic, or piezoelectric-vibration exciter 41, which, as also indicated in FIG. 3, can be positioned for example in the middle of the at least one measuring tube 10 and/or can also be the only vibration exciter of the exciter arrangement or of the measuring transducer formed thereby that causes vibrations of the at least one measuring tube. Moreover, a temperature measuring arrangement 71 serving to detect temperatures within the tube arrangement and/or a strain measuring arrangement serving to detect mechanical stresses within the tube arrangement can, for example, also be provided in the measuring transducer.

To process the vibration measurement signals s1, s2 supplied by the transducer, the transformer circuit US also has measurement and control electronics DSV. The measurement and control electronics DSV are, as shown schematically in FIG. 3, electrically connected to the measuring transducer MW or its sensor arrangement 51, 52 and are configured to receive and evaluate the aforementioned vibration measurement signals s1, s2, namely to determine analog and/or digital mass-flow-rate measurement values representing the mass flow rate based upon the at least two vibration measurement signals s1, s2, and if necessary also to output them, for example in the form of digital values. The vibration measurement signals s1, s2 generated by the measuring transducer MW and fed to the transformer circuit US or the measurement and control electronics DSV provided therein, e.g., via electrical connecting lines, can initially also be pre-processed there, for example pre-amplified, filtered, and digitized. According to a further embodiment of the invention, the measurement and control electronics DSV accordingly have a first measuring signal input for the vibration measuring signal s1 and at least one second measuring signal input for the vibration measuring signal s2, and the measurement and control electronics DSV are further configured to determine the aforementioned phase difference from the said vibration measuring signals s1, s2. In addition, the measurement and control electronics DSV can also be configured to determine each aforementioned phase angle and/or at least one signal frequency and/or one signal amplitude from at least one of the applied vibration measurement signals s1, s2, for example namely to generate during operation a sequence of digital phase values representing the respective phase angle and/or a sequence of digital frequency values representing the signal frequency and/or a sequence of digital amplitude values representing the signal amplitude. According to a further embodiment of the invention, the measurement and control electronics DSV have a digital phase output and a digital amplitude output. In addition, the measurement and control electronics DSV are also designed to output an amplitude sequence at the amplitude output, namely a sequence of digital amplitude values determined on the basis of at least one of the vibration measurement signals, e.g., quantifying the signal amplitude of one of the vibration measurement signals, and a phase sequence at the phase output, namely a sequence of digital phase values determined on the basis of the vibration measurement signals.

The measurement and control electronics DSV can also be implemented, for example, by means of a microcomputer provided in the transformer circuit US, for example implemented by means of a digital signal processor DSP, and by means of program codes implemented accordingly and running therein. The program codes can be stored persistently in a non-volatile data memory EEPROM of the microcomputer, for example, and loaded into a volatile data memory RAM integrated into the microcomputer when the microcomputer is started. As already indicated, the vibration measurement signals s1, s2 are to be converted into corresponding digital signals for processing in the microcomputer by means of corresponding analog-to-digital converters (A/D converters) of the measurement and control electronics DSV or the transformer circuit US formed thereby; cf., in this regard, for example, US-B 63 11 136 or US-A 2011/0271756 mentioned above. Correspondingly, according to a further embodiment, in the measurement and control electronics, a first analog-to-digital converter for the first vibration measurement signal and a second analog-to-digital converter for the second vibration measurement signal are provided.

To control the measuring transducer, the transformer circuit US, as shown schematically in FIG. 3 as a block diagram, also has drive electronics Exc electrically coupled both to the exciter arrangement—for example, connected to the exciter arrangement via electrical connecting lines—and to the measurement and control electronics DSV—for example, connected or electrically coupled via a digital bus internal to the transformer circuit.

The drive electronics Exc and the measurement and control electronics DSV as well as other electronic components of the transformer circuit US that serve to operate the measuring system, such as an internal power supply circuit VS for providing internal DC supply voltages and/or transmitting and receiving electronics COM for communicating with a higher-level measurement data processing system or an external field bus, can (as is also readily apparent from a combined view of FIGS. 2 and 3) also be housed, for example, in a corresponding electronics housing 200 that is in particular impact—and/or explosion-proof and/or hermetically sealed. The said electronics housing 200 can, for example—as shown in FIG. 2 or 3—be mounted on the aforementioned transducer housing 100 to form a vibronic measuring system or a Coriolis mass flow meter in a compact design.

The electrical connection of the measuring transducer MW to the transformer circuit US can be effected by means of corresponding electric connecting lines and corresponding cable feedthroughs. In this case, the connecting lines can be formed at least partially as electric conductor wires sheathed at least in some sections by electric insulation, for example in the form of “twisted pair” lines, ribbon cables, and/or coaxial cables. As an alternative or in addition thereto, the connecting lines can also be formed at least in some sections by means of printed conductors of a printed circuit board, especially a flexible, optionally varnished printed circuit board.

In order to visualize measurement values generated internally by the measuring system and/or, possibly, status messages generated internally by the measuring system, such as an error message or an alarm, on-site and/or to operate the measuring system on-site, the measuring system can further comprise a display element HMI1 that communicates at least intermittently with the transformer circuit US and/or an operating element HMI2 that communicates at least intermittently with the transformer circuit US, such as an LCD, OLED, or TFT display placed in the aforementioned electronics housing 200 behind a window provided therein, as well as a corresponding input keyboard and/or a touchscreen (as a combined display and operating element). According to a further embodiment of the invention, the operating element HMI2 is designed to convert one or more manual inputs (of a user of the measuring system) into one or more control signals, e.g., also containing one or more (control) commands for the transformer circuit US, and to send them to the transformer circuit US. Accordingly, the transformer circuit US can also be configured to receive and process one or more control signals from the operating element HMI2, possibly also containing one or more (control) commands, for example to execute one or more (control) commands transmitted by means of one or more control signals. Alternatively or additionally, the transformer circuit can also be configured to generate control signals for the aforementioned display element HMI1 and to output them to the display element HMI1. In addition, the display element HMI1 can be configured to receive and process one or more control signals from the transformer circuit US, for example to display one or more messages transmitted by means of one or more control signals.

The drive electronics Exc of the measuring system are in particular designed to be operated intermittently in a first operating mode I and to generate a—for example, bipolar and/or at least temporarily periodic, possibly also harmonic-electrical drive signal e1 in said first operating mode I and thus to feed electrical power into the exciter arrangement in such a way that the at least one measuring tube executes forced mechanical vibrations—for example, also causing Coriolis forces in the measuring medium flowing through the at least one measuring tube—with at least one useful frequency f_{N}, namely a vibration frequency predetermined by the electrical driver signal e1 or a (useful) signal component E1 thereof, in particular corresponding to a resonance frequency of the measuring transducer, or that each of the vibration measuring signals s1, s2, as also indicated in FIG. 4, each contains a useful signal component S1* or S2*, namely a (spectral) signal component with a signal frequency corresponding to the useful frequency. The driver signal e1 can accordingly be, for example, a harmonic electric signal that forms the aforementioned signal component E1 that determines the useful frequency f or, for example, can also be a multi-frequency electric signal that is composed of multiple (spectral) signal components and contains the aforementioned signal component E1, and that may also be periodic for a specifiable time period. In addition, the measurement and control electronics are specifically designed to control the drive electronics Exc in such a way that the drive electronics operate in the first operating mode, in particular temporarily and/or for longer than a reciprocal of the useful frequency and/or for more than 10 ms in each case, and that the at least one measuring tube (with drive electronics operating in the first operating mode) carries out forced vibrations at least during a first measuring interval, in particular corresponding to more than a reciprocal (1/f_{N}) of the useful frequency f_{N} and/or lasting longer than 10 ms. To set or measure the useful frequency f_{N}, the drive electronics can for example have one or more phase locked loops (PLL), as is quite common in vibronic measuring systems of the type in question or Coriolis mass flow meters. According to a further embodiment of the invention, the drive electronics Exc have a digital frequency output. In addition, the drive electronics Exc are also configured to output at said frequency output a frequency sequence, specifically a sequence of digital frequency values that quantify the signal frequency set for the driver signal e1, for example specifically the currently set useful frequency (or the signal frequency of its signal component E1). According to a further embodiment of the invention, it is further provided that the aforementioned phase output of the measurement and control electronics DSV be electrically connected to a phase input formed, for example, by means of a phase comparator provided within the drive electronics Exc. The said phase comparator can, for example, also be configured to detect a phase difference between the aforementioned signal component E1 of the driver signal e1 and at least one of the aforementioned useful components S1*, S2*, and/or to determine an extent of the said phase difference. In addition, the amplitude output of the measurement and control electronics DSV can also be electrically connected to an amplitude input of the drive electronics Exc which detects the amplitude of the signal component or the vibrations excited thereby in the at least one measuring tube.

The aforementioned (forced) mechanical vibrations excited by means of the drive electronics Exc and the exciter arrangement (41) connected thereto can—as is quite common in vibronic measuring systems of the type in question, not least also Coriolis mass flow meters—for example, be bending vibrations of the at least one measuring tube 10 about an associated rest position, where the useful frequency f_{N} can, for example, be set as an instantaneous resonant frequency, also dependent upon the density and/or the viscosity of the measuring substance carried in the at least one measuring tube, of a fundamental bending vibration mode of the at least one measuring tube 10 having only a single vibration trough.

As a result of vibrations of the at least one measuring tube 10, e.g., the aforementioned bending vibrations, Coriolis forces can be generated, as is known, in the measured material flowing through the at least one measuring tube; this in particular in such a way that each of the aforementioned useful signal components S1*, S2* of the vibration measurement signals s1 or s2 has a respective (spectral) measurement component S1′ or S2′ with a signal frequency corresponding to the useful frequency f_{N} and a phase angle dependent upon the mass flow rate m of the measured material flowing through the measuring transducer MW (S1′=f(m), S2′=f(m)); thus, as also indicated in FIG. 4, between the measuring component S1′ of the vibration signal s1 and the measuring component S2′ of the vibration signal s2, there exists a phase difference Δφ12 (Δφ₁₂=f(m)) that is dependent upon the said mass flow rate m.

The measurement and control electronics DSV are accordingly also configured to evaluate the first and second vibration measurement signals s1, s2, namely based upon vibration measurement signals s1, s2 received during at least one or more of the aforementioned first measuring intervals, e.g., on the basis of a corresponding first phase difference Δφ12*, namely a difference between the phase angle φ1* of the vibration measurement signal s1 (or useful signal component S1* thereof) received (during one or more first measuring intervals) and the phase angle φ2 of the vibration measurement signal s2 (or useful signal component S2* thereof) (received during one or more first measuring intervals) to determine one or more, e.g., also digital, mass-flow-rate measured values X_{M}, namely measurement values representing the mass flow rate (of the measuring substance guided in the at least one measuring tube).

According to a further embodiment of the invention, the measurement and control electronics are furthermore set up, based upon the vibration measurement signals s1, s2 received during one or more first measuring intervals, to first determine one or more, in particular digital, (first) phase difference measurement values X_{Δφ1}, each of which represents the first phase difference Δφ12* (of the vibration measurement signals s1, s2 received during one or more first measuring intervals), for example in order to determine one or more of the aforementioned mass-flow-rate measurement values X_{M} using one or more (first) phase difference measurement values X_{φ1}. Alternatively or in addition, the measurement and control electronics can be further configured to determine, based upon vibration measurement signals s1 received during one or more first measuring intervals, one or more in particular digital (first) phase angle measurement values X_{φ1} representing the first phase angle φ1* (of the vibration measurement signal s1 received during one or more first measuring intervals) and/or to determine, based upon vibration measurement signals s2 received during one or more first measuring intervals, one or more in particular digital (second) phase angle measurement values X_{φ2} representing the second phase angle φ2* (of the vibration measurement signal s2 received during one or more first measuring intervals). The aforementioned phase angles φ1*, φ2* or phase angle measurements X_{φ1}, X_{φ2} can be determined, e.g., in reference to the electrical driver signal e1 or also to an internal (clock) reference signal of the transformer circuit US, in particular generated by means of the measurement and control electronics DSV or the drive electronics Exc, with a clock frequency corresponding to the useful frequency, for example as a phase difference to the useful signal component E1 of the electrical driver signal e1 or to the aforementioned (clock) reference signal.

As already mentioned, when the drive electronics Exc are operating in the first operating mode or when the driver signal e1 is fed into the exciter arrangement, each of the vibration measurement signals s1, s2 (as also indicated in FIG. 4 or as can be seen from a combined view of FIGS. 1 and 4) can, in addition to the aforementioned measurement component S1′ or S2′, also each have an interference component S1″ or S2″ that has the same frequency, but that is nevertheless undesirable, each with a phase angle dependent upon the aforementioned signal component E1 of the driver signal e1 and an amplitude which is also dependent upon the said signal component E1. As also indicated in FIG. 4, the phase angles and/or the amplitudes of the interference components S1″ or S2″ may differ from each other. In addition, the same phase angles and amplitudes can vary during operation, e.g., as a result of a changing useful frequency and/or a changing amplitude of the signal component E1, or depending upon the measured material in the at least one measuring tube. The aforementioned interference components can, for example, result from an electromagnetic coupling of the driver signal into the vibration signals or from aging or (over) loading of the measuring transducer or the measuring system formed by it.

Due to the aforementioned interference component S1″ or S2″ contained in the vibration measurement signals s1, s2 or their useful signal components S1*, S2*, the (first) phase difference Δφ₁₂* actually measurable between the said useful signal components S1*, S2* when the drive electronics Exc are operating in the first operating mode is not dependent only upon the mass flow rate m (Δφ12*=f(m, E1)), or, conversely, the said phase difference Δφ12* (as can also be seen from FIG. 4) can deviate significantly from the phase difference Δφ12 established between the measuring components S1′, S2′ (Δφ12*+Δφ12). In other words, the vibration measurement signals s1, s2 or their useful signal components S1*, S2* can have corresponding phase errors Err (Err˜Δφ12*−Δφ12) caused by the aforementioned interference component S1″ or S2″.

In order to detect the aforementioned interference component S1″, S2″ in the vibration measurement signals s1, s2 or a corresponding phase error Err of the vibration measurement signals as early and yet reliably as possible and, if necessary, also to quantify and/or compensate for them during operation of the measuring system, the drive electronics Exc are also designed to occasionally operate in a second operating mode, e.g., to be switched from the aforementioned first operating mode I to the second operating mode II and in said second operating mode to suspend generation of the electrical driver signal e1, such that no electrical power is fed into the exciter arrangement by the drive electronics during this time and that forced mechanical vibrations of the at least one measuring tube, e.g., during the (previous) first operating mode I, are replaced by free, damped vibrations; this, for example, also in such a way that the drive electronics Exc occasionally operate in alternating fashion in the first operating mode I or in the second operating mode II, or switch multiple times from the first operating mode I to the second operating mode and back to the first operating mode I. As can be seen from FIG. 4, a temporary interruption or switching off of the driver signal e1 can, on the one hand, cause an amplitude (|S1**|, |S2**|) of each of the useful signal components S1**, S2** of the signal measurement signals s1, s2 generated during the second operating mode to be significantly smaller in comparison to the amplitudes (|S*1|, |S*2|) of each of the useful signal components S1*, S2* detected when the drive electronics Exc are operating in the first operating mode I. On the other hand, this switching off of the driver signal e1 also has the result that the useful signal components S1**, S2** then do not contain or no longer contain the aforementioned interference components S1″, S2″ due to the absence of the driver signal e1, and thus correspond substantially to the measuring components S1′, S2′, so that the measurable phase difference Δφ12** established between the useful signal components S1**, S2** then corresponds very precisely to the phase difference Δφ12 actually required for measuring the mass flow rate m (Δφ12**=Δφ12). Conversely, with the knowledge of both the first phase difference Δφ12* as well as the second phase difference Δφ12** or the phase angle of each of the useful signal components, the aforementioned phase error (Err˜ Δφ12*−Δφ12**) can be at least approximately determined or quantified during operation of the measuring system. Accordingly, the measurement and control electronics DSV are also configured to cause or initiate a change of the drive electronics Exc from the first operating mode to the second operating mode (and vice versa) during operation of the measuring system, both occasionally and for example also in a time—or event-controlled manner, in such a way that the at least one measuring tube 10, with the drive electronics Exc in the second operating mode, executes free damped vibrations at least during a (for example, predetermined and/or adaptable) second measuring interval, and also to receive the (corresponding) vibration measuring signals s1, s2 during one or more second measuring intervals. In addition, the measurement and control electronics DSV of the measuring system according to the invention are also configured to evaluate the vibration measurement signals s1, s2 received during one or more first and second measurement intervals in each case, namely to determine, based upon these vibration measurement signals s1, s2 (received during one or more first and second measuring intervals in each case), one or more, e.g., digital, phase error measurement values X_{Err}. For this purpose, the measurement and control electronics DSV can, as already indicated, be configured for example to cause the drive electronics Exc to change from the first operating mode I to the second operating mode II or vice versa, in each case automatically, for example in a time- or event-controlled manner. Alternatively or in addition, the measurement and control electronics DSV can also be configured to effect the aforementioned change of the drive electronics Exc from the first operating mode I to the second operating mode II based upon a control signal that may also be generated externally to the transformer circuit US. The said control signal can, for example, be generated by means of the aforementioned operating element HMI2 or also by the aforementioned data processing system (connected to the measuring system), and can have been received via the aforementioned transmitting and receiving electronics COM. In addition, the control signal can contain, for example, a message reporting the mass flow as stationary and/or the measured material as inhomogeneous, and/or a control command (directly) causing the change from the first operating mode I to the second operating mode II.

In the measuring system according to the invention, the phase error measurement values X_{Err} are in particular those measurement values that represent, e.g., quantify, a (measurement) deviation of one or more first phase differences Δφ12* (of the vibration measurement signals s1, s2 received during one or more first measuring intervals) from one or more second phase differences Δφ12** of the vibration measurement signals s1, s2 received during one or more second measuring intervals. Alternatively or in addition, phase error measurements X_{Err} can also be those measurement values that represent or quantify a (measurement) deviation of one or more first phase angles φ1* (of the vibration measurement signal s1 received during one or more first measuring intervals) from one or more third phase angles φ1** of the vibration measurement signal s1 received during one or more second measuring intervals, and/or a (measurement) deviation of one or more second phase angles φ2* (of the vibration measurement signal s2 received during one or more first measuring intervals) from one or more fourth phase angles φ2** of the vibration measurement signal s2 received during one or more second measuring intervals. In addition, one or more phase error measurements X_{Err} also represent or quantify a temporal derivative (of first and/or higher order) of at least one of the aforementioned (measurement) deviations. The aforementioned (measurement) deviation can also, for example, be an absolute or a relative (measurement) deviation. The aforementioned (third) phase angles φ1** and (fourth) phase angles φ2** can, for example, be measured very simply (in the same way as the phase angles φ1* or φ2*) as a phase difference with respect to the aforementioned (clock) reference signal.

The second measuring interval or the second operating mode II can also advantageously be selected such that the second measuring interval and/or the second operating mode II each last longer than 10 ms (milliseconds), e.g., more than 100 ms, and/or each longer than a reciprocal value (1/f_{N}) of the useful frequency, for example even longer than 5 times the said reciprocal value. Alternatively or in addition, the second measuring interval or the second operating mode II can be selected so that they are each shorter than 1 s (second).

According to a further embodiment of the invention, the measurement and control electronics DSV are further configured to effect the change of the drive electronics Exc from the first operating mode to the second operating mode in a time-controlled manner or to carry it out in a time-controlled manner, e.g., in such a way that said change, or, conversely, a change from the second operating mode II back to the first operating mode I, takes place cyclically or in a time-controlled manner multiple times within a predetermined or predeterminable period of time. The measurement and control electronics and/or the drive electronics can also be configured, for example, to cyclically change the drive electronics from the first operating mode to the second operating mode, in such a way that the drive electronics change from the first operating mode to the second operating mode multiple times within one cycle and vice versa, and/or that the drive electronics are predominantly operated in the first operating mode within one cycle, and/or that the drive electronics, within one cycle, are operated in the first operating mode at least as often and/or as long as in the second operating mode.

The phase error measurements X_{Err} can also be used for example to check the measuring system and/or the measured material, e.g., to determine whether the measuring system is subject to a fault, possibly even an irreversible fault, and/or to determine whether one or more material parameters of the measured material lie outside a specification defined for it. Alternatively or in addition, phase error measurement value X_{Err} can also, for example, be taken into account accordingly when determining the mass-flow-rate measurement values X_{M}, e.g., in that the measurement and control electronics are also configured to calculate, during operation of the measuring system, correction values corresponding to the phase error Err in each case using one or more phase error measurement value X_{Err} by means of the measurement and control electronics DSV, or to determine one or more (future) mass-flow-rate measurement values X_{M} using one or more phase error measurement values X_{Err}.

Accordingly, according to a further embodiment of the invention, the measurement and control electronics DSV are configured to calculate, using one or more phase error measurement values X_{Err}, at least one correction value for reducing or compensating for a phase error contained in the first phase differences Δφ12* (of the vibration measurement signals s1, s2 received during one or more first measuring intervals) and to take it into account in determining the mass-flow-rate measurement values X_{M}, or to calculate the mass-flow-rate measurement values X_{M} also using the at least one correction value. Alternatively or in addition, the measurement and control electronics DSV can also be configured to measure one or more mass-flow-rate measurement values X_{M} based also upon vibration measurement signals s1, s2 received during one or more second measuring intervals. According to a further embodiment of the invention, the measurement and control electronics are therefore in addition also configured to determine, based upon the vibration measurement signals s1, s2 received during one or more second measurement intervals, one or more, e.g., also digital, (second) phase difference measurement values X_{Δφ2**}, such that said phase difference measurement values X_{Δφ2**} are measurement values representing the (second) phase difference Δφ12** of the vibration measurement signals s1, s2 (received during one or more second measuring intervals). In addition, the measurement and control electronics DSV can be configured to determine one or more mass-flow-rate measurement values X_{M} also using one or more such phase difference measurement values X_{Δφ2**} representing the (second) phase difference Δφ12**. Alternatively or in addition, the measurement and control electronics DSV can also be configured to measure one or more phase error values X_{Err} based upon a deviation between the first and second mass-flow-rate measurement values. In addition, phase error measurements X_{Err} can also serve as a measure of the viscosity of the medium, or the phase error measurement values X_{Err}, together with a measuring-system-specific (calibration) factor K_{η}, can accordingly be converted into viscosity measurement values X_{η}(X_{η}˜K_{η}·X_{Err}).

The aforementioned compensation for the phase error Err, and if necessary also the calculation of the aforementioned correction value used to compensate for the phase error Err, as well as the checking of the measuring system or measured material, can for example be done based upon statistical calculations which are carried out using a plurality of phase error measurement values X_{Err} determined in temporal succession, or based upon characteristic values of descriptive and/or inductive statistics determined for said phase error measurements X_{Err}; this can be done advantageously on-site, if necessary without interrupting the operation of the industrial plant involving the measuring system, and/or for the case in which the measuring transducer measures a measured material flowing with a mass flow rate that is not equal to zero, in particular is at least approximately constant or stationary for a plurality of temporally successive first and second measuring intervals (m>0 and/or dm/dt≈0). For this purpose, according to a further embodiment of the invention, the measurement and control electronics DSV are configured to use a plurality of phase error measurement values X_{Err} to calculate one or more characteristic values for at least one statistical (measuring system) characteristic value, e.g., a position measure or a dispersion measure of a measurement value ensemble that includes a plurality of phase error measurement values X_{Err}, for example in such a way that one or more characteristic values quantify a (central) tendency of the phase error measurement values X_{Err} and/or that one or more characteristic values quantify a dispersion width of the phase error measurements X_{Err} about one or more of their position measures. Such a (measuring system) characteristic value can, for example, be a mode, a median, an (empirical) mean, an (empirical) variance, an (empirical) standard deviation, or a range (of the phase error measurement values X_{Err}). Alternatively or in addition, however, one or more phase error measurement values X_{Err} can also be determined in such a way that they themselves represent or quantify such a parameter of the (descriptive) statistics, i.e., one or more phase error measurement values X_{Err} can also themselves already serve as characteristic values for the at least one statistical (measuring system) characteristic value. Not least, the measurement and control electronics can also be configured to measure one or more phase error measurement values X_{Err} in such a way that they each represent or quantify a (central) tendency of the (measurement) deviation of first phase angles φ1* from third phase angles φ1** and/or of second phase angles φ2* from fourth phase angles φ2** and/or of first phase differences Δφ12* from second phase differences Δφ12**, and/or that they each represent or quantify a measure of dispersion of the (measurement) deviation of first phase angles φ1* from second phase angles φ1** and/or of second phase angles φ2* from fourth phase angles φ2** and/or of first phase differences Δφ12* from second phase differences Δφ12**. In the aforementioned case in which one or more phase error measurement values X_{Err} are calculated by means of the measurement and control electronics DSV based upon a deviation between first and second mass-flow-rate measurement values, in addition, one of the phase error measurement values X_{Err} can also represent in each case a difference between a first mass-flow-rate measurement value and a second mass-flow-rate measurement value determined temporally immediately before or after it and/or a position measure for a plurality of such differences between first and second mass-flow-rate measurement values and/or a difference between position measures determined in each case for a plurality of first and second mass-flow-rate measurement values and/or a dispersion measure for a plurality of such differences between first and second mass-flow-rate measurement values and/or a difference between scatter measures determined in each case for a plurality of first and second mass-flow-rate measurement values.

A check of the measuring system or measured material, e.g., also on-site or during operation of the plant, can also be carried out, among other things, by comparing one or more phase error measured values X_{Err} with one or more (phase error) reference values or (phase error) threshold values; this can be done, for example, in such a way that phase error measured values X_{Err} which represent rapidly varying and/or strongly fluctuating or merely temporary measurement deviations over time or that exceed a predetermined level are evaluated as an indicator of a disturbance of the measured material, e.g., in the form of a multiphase flow and/or due to foreign substances entrained in the material, and/or in such a way that phase error measurement values X_{Err} which represent slowly and/or continuously increasing measurement deviations or which exceed a predetermined level are evaluated as an indicator representing a fault of the measuring transducer. Accordingly, according to a further embodiment of the invention, the measurement and control electronics DSV are furthermore configured to determine a deviation of one or more phase error measurement values X_{Err} from at least one associated phase error reference value, e.g., representing a phase error measurement value X_{Err} determined (in advance) under reference conditions and/or during a (re-) calibration of the measuring system, and/or to compare one or more phase error measurement values X_{Err} with at least one (measuring-system-specific) phase error threshold value, for example representing a maximum permissible phase error measurement value X_{Err}, MAX or a fault of the measuring system and/or of the measured material. In addition, the measurement and control electronics DSV can also be configured to issue a corresponding (error) message, e.g., also by means of the aforementioned display element HMI1, if one or more phase error measurement values X_{Err} have exceeded the aforementioned at least one phase error threshold value. The aforementioned phase error reference values or phase error threshold values can be determined at least in part, for example, by the manufacturer (ex works) and/or in the course of a possibly recurring calibration of the measuring system (under reference conditions) on-site, and can be stored accordingly in the transformer circuit, for example in a non-volatile (data) memory of the transformer circuit US, such as the aforementioned non-volatile data memory EEPROM.

Although the determination of the phase error Err, as already mentioned, can also be carried out when the measured material is flowing through the measuring transducer with a mass flow other than zero, it can be advantageous—not least when using the measuring system in a plant or a process with a (highly) dynamic mass flow such that the measured material regularly has a non-stationary and/or highly temporally changing mass flow rate—to introduce or provide, at least for a short period of time required for determining the phase error measurement value X_{Err}, a mass flow in the system which is as stationary as possible or at most slightly fluctuating, or, conversely, to report such a stationary mass flow to the measuring system. For this purpose, according to a further embodiment of the invention, the measurement and control electronics or the transformer circuit US formed thereby are further configured (when the drive electronics Exc are operating in the first operating mode I or before the drive electronics Exc are switched from the first to the second operating mode) to generate a message, e.g., to output it by means of the aforementioned control signal and/or to transmit it to the aforementioned display element HMI1, which indicates or causes the mass flow of the measured material guided in the at least one measuring tube to be set to a constant (mass flow) value, for example also zero. Alternatively or in addition, the measurement and control electronics DSV or the transformer circuit US formed thereby can also be configured, based upon a control signal applied to the transformer circuit US, e.g., triggered by a (start) command transmitted therewith and/or a message transmitted therewith that the mass flow of the measured material carried in the at least one measuring tube is constant or is zero, to effect a change, possibly also multiple changes, of the drive electronics from the first operating mode to the second operating mode (and vice versa).

1-21. (canceled)

22. A vibronic measuring system, comprising:
a transducer with at least one measuring tube, an exciter arrangement, and a sensor arrangement; and
an electronic transformer circuit which is electrically coupled to both the exciter arrangement and the sensor arrangement, wherein the electronic transformer circuit includes a measurement and control electronics and a drive electronics connected to the measurement and control electronics and/or controlled by the measurement and control electronics,
wherein the at least one measuring tube is configured to guide a fluid measured substance which flows at least intermittently, and to be vibrated,
wherein the exciter arrangement is configured to convert electric power fed to the exciter arrangement into mechanical power causing forced mechanical vibrations of the at least one measuring tube,
wherein the sensor arrangement is arranged to detect mechanical vibrations of the at least one measuring tube and to provide a first vibration measurement signal representing at least in part first vibrational movements of the at least one measuring tube and at least a second vibration measurement signal representing at least in part second vibrational movements of the at least one measuring tube,
wherein the drive electronics are configured to generate an electrical drive signal in a first operating mode and thus to feed electrical power into the exciter arrangement so that the at least one measuring tube carries out forced mechanical vibrations with at least one useful frequency and the first vibration measurement signal has a first phase angle and the second vibration measurement signal has a second phase angle,
wherein the drive electronics are configured in a second operating mode to suspend generation of the electrical driver signal so that during the second operating mode no electrical power is fed into the exciter arrangement by the drive electronics,
wherein the measurement and control electronics are configured to control the drive electronics so that the drive electronics initially operate in the first operating mode and the at least one measuring tube with drive electronics operating in the first operating mode carries out forced vibrations at least during a first measuring interval, and that the drive electronics subsequently change from the first operating mode to the second operating mode and vice versa or operate alternately in the first operating mode and in the second operating mode, as a result of which the at least one measuring tube with drive electronics operating in the second operating mode carries out free damped vibrations at least during a second measuring interval and the first vibration measurement signal has a third phase angle and the second vibration measurement signal has a fourth phase angle, and
wherein the measurement and control electronics are configured to receive and evaluate the first and second vibration measurement signals, specifically to determine one or more mass-flow-rate measurement values, namely measurement values representing the mass flow rate of the measured substance carried in the at least one measuring tube on the basis of at least one or more first and second vibration measurement signals received during at least one or more first measuring intervals, and to determine measurement values representing, based upon first and second vibration measurement signals received respectively during one or more first and second measuring intervals, one or more phase error measurement values, specifically a measurement deviation of one or more first phase angles of the first vibration measurement signal received during the one or more first measuring intervals from one or more third phase angles of the first vibration measurement signal received during one or more second measuring intervals and/or a measurement deviation of one or more second phase angles of the second vibration measurement signal received during the one or more first measuring intervals from one or more fourth phase angles of the second vibration measurement signal received during one or more second measuring intervals and/or a measurement deviation of one or more first phase differences of the first and second vibration measurement signals received during the one or more first measuring intervals from one or more second phase differences of the first and second vibration measurement signals received during one or more second measuring intervals.

23. The vibronic measuring system according to claim 22,
wherein the measurement and control electronics are further configured to determine one or more mass-flow-rate measurement values using the one or more phase error measurement values, and/or
wherein the measurement and control electronics are configured to use a plurality of phase error measurement values to calculate one or more characteristic values for at least one statistical measuring system characteristic value.

24. The vibronic measuring system according to claim 22,
wherein the one or more phase error measurement values represent a central tendency of the measurement deviation of one or more first phase angles from one or more second phase angles, and/or
wherein the one or more phase error measurement values represent a central tendency of the measurement deviation of one or more third phase angles from one or more fourth phase angles, and/or
wherein the one or more phase error measurement values represent a central tendency of the measurement deviation of one or more first phase differences from one or more second phase differences, and/or
wherein the one or more phase error measurement values represent a dispersion parameter of the measurement deviation of one or more first phase angles from one or more second phase angles, and/or
wherein the one or more phase error measurement values represent a dispersion parameter of the measurement deviation of one or more second phase angles from one or more fourth phase angles, and/or
wherein the one or more phase error measurement values represent a dispersion parameter of the measurement deviation of one or more first phase differences from one or more second phase differences.

25. The vibronic measuring system according to claim 22,
wherein the measurement and control electronics are configured to determine a deviation of the one or more phase error measurement values from at least one phase error reference value, and/or
wherein the measurement and control electronics are configured to compare the one or more phase error measurement values with at least one phase error threshold value.

26. The vibronic measuring system according to claim 23, wherein the measurement and control electronics are configured to measure the mass-flow-rate measurement values based also upon first and second vibration measurement signals received during one or more second measuring intervals.

27. The vibronic measuring system according to claim 22, wherein the measurement and control electronics are configured to determine, based upon the first vibration measurement signals received during the one or more first measuring intervals, one or more first phase angle measurement values representing the first phase angle of the first vibration measurement signal received during the one or more first measuring intervals.

28. The vibronic measuring system according to claim 27, wherein the measurement and control electronics are configured to determine, based upon second vibration measurement signals received during the one or more first measuring intervals, one or more second phase angle measurement values representing the second phase angle of the second vibration measurement signal received during one or more first measuring intervals.

29. The vibronic measuring system according to claim 22, wherein the measurement and control electronics are configured to determine, based upon first vibration measurement signals received during the one or more first measuring intervals, one or more third phase angle measurement values representing the third phase angle of the first vibration measurement signal received during the one or more second measuring intervals.

30. The vibronic measuring system according to claim 29, wherein the measurement and control electronics are configured to determine, based upon second vibration measurement signals received during the one or more second measuring intervals, one or more fourth phase angle measurement values representing the fourth phase angle of the second vibration measurement signal received during the one or more second measuring intervals.

31. The vibronic measuring system according to claim 22, wherein the measurement and control electronics are configured to determine, based upon first and second vibration measurement signals received during the one or more first measuring intervals, one or more first phase difference measurement values, namely measurement values representing the first phase difference of the first and second vibration measurement signals received during the one or more first measuring intervals.

32. The vibronic measuring system according to claim 31, wherein the measurement and control electronics are configured to determine one or more mass-flow-rate measurement values using the one or more first phase difference measurement values.

33. The vibronic measuring system according to claim 22, wherein the measurement and control electronics are configured to determine, based upon first and second vibration measurement signals received during the one or more second measuring intervals, one or more second phase difference measurement values, namely measurement values representing the second phase difference of the first and second vibration measurement signals received during the one or more second measuring intervals.

34. The vibronic measuring system according to claim 33, wherein the measurement and control electronics are configured to determine one or more mass-flow-rate measurement values using one or more second phase difference measurement values.

35. The vibronic measuring system according to claim 22,
wherein the electronic transformer circuit is configured to generate a message which indicates or causes the mass flow of the measurement material guided in the at least one measuring tube to be set to a constant value, and/or
wherein the electronic transformer circuit is configured to effect a change of the drive electronics from the first operating mode to the second operating mode and vice versa automatically and/or based upon a control signal applied to the electronic transformer circuit.

36. The vibronic measuring system according to claim 22, further comprising: a display element.

37. The vibronic measuring system according to claim 36,
wherein the electronic transformer circuit is configured to generate control signals for the display element and to output the control signals to the display element, and/or
wherein the display element is configured to receive and process the control signals from the electronic transformer circuit.

38. The vibronic measuring system according to claim 36, further comprising: an operating element.

39. The vibronic measuring system according to claim 38,
wherein the operating element is configured to convert one or more manual inputs into one or more control signals and to send the one or more control signals to the transformer circuit, and/or
wherein the transformer circuit is configured to receive and process the one or more control signals from the operating element.

40. The vibronic measuring system according to claim 22,
wherein the sensor arrangement for detecting mechanical vibrations of the at least one measuring tube has a first vibration sensor providing the first vibration measurement signal and a second vibration sensor providing the second vibration measurement signal, and/or
wherein the exciter arrangement for exciting vibrations of the at least one measuring tube has a first vibration exciter, and/or
wherein the drive electronics are electrically connected to the exciter arrangement, and/or
wherein the measurement and control electronics are electrically coupled to the sensor arrangement, and/or
wherein the measurement and control electronics have a first analog-to-digital converter for the first vibration measurement signal and a second analog-to-digital converter for the second vibration measurement signal.

41. The vibronic measuring system according to claim 22, wherein the measurement and control electronics are arranged to determine phase error values also in the case in which the measurement material flows through the measuring transducer at a mass flow rate that is different from zero.

42. A use of a vibronic measuring system according to claim 22 for measuring and/or monitoring a fluid measurement material that is flowing at least intermittently in a pipeline.
